(19) United States
(12) Patent Application Publication
(10) Pub. No.: US 2024/0400923 A1
(43) Pub. Date: Dec. 5, 2024

(54) ACTIVATED OXIDIZING COMPOSITIONS FOR REMOVING SULFUR COMPOUNDS FROM HYDROCARBON FUELS AND WASTEWATER

(71) Applicant: JDS CHEMICALS, LLC, Oologah, OK (US)

(72) Inventor: Robert Scott DECKER, Joplin, MO (US)

(21) Appl. No.: 18/203,437

(22) Filed: May 30, 2023

(51) Int. Cl. C10L 3/10; C02F 1/20; C02F 1/76; C10G 75/02

(52) U.S. Cl. CPC C10L 3/103; C02F 1/20; C02F 1/76; C10G 75/02; C02F 2101/101; C02F 2103/18; C10G 2300/4075; C10L 2290/541

(57) ABSTRACT

An oxidizing composition for removing hydrogen sulfide (H₂S) from a gaseous or liquid stream includes mixture products of water, sodium hypochlorite, a chelating agent, and a transition metal compound. The chelating agent can be etidronic acid; the transition metal compound can be an iron (III) compound, such as ferric sulfate. The oxidizing composition is formed by (i) combining water, chelating agent, and transition metal compound to form an activator composition and (ii) mixing the activator composition with a sodium hypochlorite solution to adjust the pH, such as for a particular use. Oxidizing compositions suitable for removing H₂S from natural gas pipelines or hydrocarbon fuel have a pH of about 10-10.3. Oxidizing compositions suitable for removing H₂S from wastewater have a pH of about 9.0-10.1. Oxidizing compositions suitable for cleaning pipelines and provide anti-scaling and anti-corrosion effects have a pH of about 8-9.8.

### BACKGROUND

Natural gas is an abundant and important energy source used for a variety of purposes. Natural gas typically contains gaseous lower alkanes, primarily methane with lesser amounts of ethane, propane, butane. A major problem that affects many natural gas resources is the inclusion of sulfur-based compounds, primarily hydrogen sulfide gas (H₂S), along with the alkanes, yielding “sour gas”. Natural gas is usually considered “sour” if there are more than 5.7 milligrams of H₂S per cubic meter of natural gas, which is equivalent to approximately 4 ppm under standard temperature and pressure.

Other hydrocarbon fuels, such as diesel and naphtha, may contain H₂S and other sulfur compounds, which diminishes their value as fuels because of oxidized sulfur emissions.

H₂S is highly toxic and can cause serious injury and death at relatively low concentrations. Besides high toxicity, H₂S is very corrosive to pipelines and must be removed to produce usable natural gas. Before raw natural gas containing hydrogen sulfide can be used, the raw gas must be treated to remove sulfur to acceptable levels.

The removal of H₂S is referred to as “sweetening”, and the sweetened product lacks the sour, foul odor of hydrogen sulfide. The removed H₂S can be converted to elemental sulfur in a Claus process or a liquid redox process, and/or it can be treated in a wet sulfuric acid process unit to produce sulfuric acid. Alternatively, highly H₂S concentrated gas can be recompressed by gas compressor units designed to handle highly toxic and corrosive gas and injected back into the natural gas reservoir.

The Claus process (named after Carl Friedrich Claus) is an important sulfur recovery process in the industry, recovering elemental sulfur from gaseous H₂S. The Claus process recovers elemental sulfur from an acid gas stream through partial oxidation of the H₂S to SO₂ and then to sulfur. Typically, the Claus process works along with an acid gas removal system, which removes H₂S from the sour gas stream. The resulting acid gas stream which generally contains hydrogen sulfide, carbon dioxide and moisture can be treated through a Claus unit. In general, the natural gas stream, or syngas stream containing hydrogen sulfide is not sent directly to a Claus plant, because the Claus plant will oxidize the valuable natural gas. Rather, a Claus plant is typically used to treat concentrated streams containing more than 50% H₂S. Typically, a Claus plant can remove 95-98% of the inlet sulfur. Thus, either a modified Claus process if performed or another H₂S removal process is performed upstream of the Claus process.

For example, the GT-SPOC (Sulphur Partial Oxidation Catalysis) process is a Claus-type process in which the burner and reaction furnace section is replaced by a catalytic section. The catalytic section is a short contact time reactor, with millisecond residence time. The catalytic section can operate with lean H₂S (<25% H₂S) and produces less carbonyl sulfide (COS), carbon disulfide (CS₂), and dissolved H₂S in the molten elemental sulfur.

Another example is the GT-DOS (Direct Oxidation to Sulfur) process, which converts H₂S catalytically directly into sulfur, from lean (low concentration) H₂S streams (0.2% to 40% H₂S). The sulfur conversion efficiency is approximately 90% in a single pass and can attain 95-98% overall conversion efficiency. The GT-DOS process is most commonly used for sulfur recovery from an acid gas stream from an Acid Gas Removal unit. In that configuration, the H₂S in the acid gas is partially oxidized directly to sulfur (without first producing SO₂, as in the Claus process). Unlike the Claus process, there is no burner and reaction furnace, which means the GT-DOS process can directly handle lean acid gas streams.

The Stretford process is a liquid-redox process and was the first liquid phase, oxidation process for converting H₂S into sulfur to gain widespread acceptance.

The LO-CAT process is also a liquid-redox process and is a wet scrubbing, liquid redox system that uses a chelated iron solution to convert H₂S to elemental sulfur. It does not use any toxic chemicals and does not produce any hazardous waste byproducts. The LO-CAT process can directly treat a gas stream, or treat the H₂S containing stream from an Acid Gas Removal unit, although the direct treat capability is limited to low pressure streams.

The SulFerox is a proprietary iron Redox process in which a sour gas stream containing H₂S is contacted with a liquid containing soluble ferric (Fe³⁺) ions. In the process, H₂S is oxidized to elemental sulfur and the ferric (Fe³⁺) ions are reduced to ferrous (Fe²⁺) ions. The system is regenerable, wherein the ferrous (Fe²⁺) ions are reconverted to ferric (Fe³⁺) ions by oxidation with air. Sulfur is recovered from the aqueous solution as a moist cake. The Sulferox process can directly treat a gas stream, or treat the H₂S-containing stream from an Acid Gas Removal unit, although the direct treat capability is limited to low pressure streams.

The Thiopaq O&G process integrates gas purification with sulfur recovery in a single unit. The sour feed gas first comes into contact with a lean solution in the absorber. This solution absorbs H₂S to form sodium sulfides, and sweet gas exits the absorber, ready for use or further processing. The process uses naturally occurring bacteria (Thiobacillus) to oxidize H₂S to elemental sulfur.

The CrystaSulf process can be used to remove H₂S from high-pressure gas. It

uses a nonaqueous solution with a high solubility for elemental sulfur. Because the elemental sulfur stays dissolved in the solution, there are no solids in the liquid circulated to the absorber. By design, CrystaSulf avoids the problems that make the aqueous sulfur recovery systems unsuitable for direct treatment of high-pressure sour gas.

Another issue is that H₂S is very corrosive to natural gas and other pipelines. Existing methods for removing H₂S from sour gas do not treat corrosion and scaling, apart from reducing exposure to H₂S, which only indirectly reduces corrosion and scaling.

As is readily apparent, there are several different processes for removing H₂S from sour gas, each having its own unique advantages and shortcomings, such as high expense, being a complicated multi-step process, production of high quantities of effluent, and use of expensive catalysts, among other things. Accordingly, there remains a need to find more efficient ways for removing H₂S from sour gas, other hydrocarbon fuels such as naphtha, and waste streams that contain H₂S or other sulfur compounds. In addition, it would be advantageous if the process of removing H₂S from a pipeline or other processing equipment also provided long-term protection against corrosion and scaling of the exposed metal surfaces.

### SUMMARY

Disclosed herein are activated oxidizing compositions for use in removing H₂S from sour gas streams, such as within or from a wellbore or a natural gas delivery line. Also disclosed are activated oxidizing compositions for use in processes that remove H₂S and other sulfur compounds from other hydrocarbon fuels, such as diesel and naphtha, and wastewater, such as municipal sewer lines or wastewater produced when treating sour gas to remove H₂S. Also disclosed are activated oxidizing compositions for use in cleaning pipelines and to provide anti-scaling and anti-corrosion effects.

The activated oxidizing compositions used to remove H₂S and other sulfur compounds from sour gas streams, other hydrocarbon fuels, and wastewater, or to clean pipelines and provide anti-scaling and anti-corrosion effects, are based on similar chemistry. The activated oxidizing compositions comprise an aqueous mixture of sodium hypochlorite (the primary source of oxidizing components), a chelating agent (e.g., etidronic acid), and one or more transition metal compounds (e.g., one more iron-based compounds). Different activated oxidizing compositions used for the various purposes may differ in pH, which is a function of the relative amounts of the various components in the composition, as will be explained below. The activated oxidizing compositions may also differ in physical form and/or stability.

In some embodiments, activated oxidizing compositions for treating sour gas, other hydrocarbon fuels, or wastewater streams to remove sulfur compounds or to clean and treat pipelines are made by first preparing an activator composition comprising an aqueous mixture of chelating agent and one or more transition metal compounds. Thereafter, the activator composition is combined with an aqueous sodium hypochlorite solution to form an activated oxidizing composition that effectively and efficiently oxidizes H₂S to elemental sulfur, which can be removed using known means (e.g., filtration of aqueous effluent). The transition metal compound, in addition to participating in reactions that activate the sodium hypochlorite to remove H₂S, is believed to impart anti-corrosion and anti-scaling protection to pipelines and other equipment.

The activated activator composition is acidic, with a pH of less than 7, typically less than 6, 5 or 4 depending on the concentration of the various components. Aqueous sodium hypochlorite (NaOCl) is basic, with a pH between about 11-13 depending on whether the composition contains a stoichiometric excess of sodium hydroxide (NaOH). A typical sodium hypochlorite solution has a pH between about 11.85 about 13, corresponding to approximately 0.25% to 0.35% excess sodium hydroxide. The pH of activated oxidizing compositions for use in removing sulfur compounds from gas or liquid streams can be adjusted by changing the relative amounts of the activator composition and sodium hypochlorite solution.

In some embodiments, the activator composition is added to the sodium hypochlorite solution in order to lower an initially high pH to a desired lower pH. Because combining the acidic activator solution and basic sodium hypochlorite solution is exothermic, it is advantageous to continuously stir the sodium hypochlorite solution while adding the activator composition to avoid local heat pockets and gas formation and overcome the buffering effects of sodium hypochlorite to arrive at the desired pH without overshooting the mark. In some cases, the pH of the mixed composition continues to drop from an initial value. Thus, care must be taken to allow the pH to reach equilibrium rather than continue to add activator composition until the desired pH is achieved.

In some embodiments, activated oxidizing compositions used to clean sour gas, other hydrocarbon fuels, and wastewater are made by first forming an activator composition by mixing a chelating agent, such as etidronic acid, and a transition metal compound, such as ferric (Fe³⁺) sulfate, with water to form an aqueous activator composition. The activator composition is then added to an aqueous sodium hypochlorite solution (e.g., 15% solution) to form the activated oxidizing composition. The activated oxidizing compositions used to clean sour gas preferably have a pH in a range of about 9.8 to about 10.5, preferably about 10 to about 10.3, with a pH of about 10.2 being more preferred. Thus, a quantity of activator composition is added to the high pH sodium hypochlorite solution until the oxidizing composition has been adjusted to a desired pH. The activated oxidizing removal composition is preferably used within a few hours or days of mixing to remove H₂S from sour gas, preferably by injecting an atomized spray into a gas pipeline or borehole.

In some embodiments, activated oxidizing compositions used to clean wastewater, such as municipal sewer water and wastewater from cleaning sour gas, are made in a similar manner but by adding an additional quantity of the activator composition in order to further lower and adjust the pH to a range of about 9.0 to about 10.1, preferably about 9.6 to about 10, more preferably about 9.7.

In some embodiments, activated oxidizing compositions used to clean pipelines and provide anti-scaling and anti-corrosion effects are made in a similar manner but by adding an additional quantity of the activator composition in order to further lower and adjust the pH to a range of about 8 to about 9.8, preferably about 8.5 to about 9.5, more preferably about 8.8 to about 9.4.

In some embodiments, activated oxidizing compositions used to clean other hydrocarbon fuels or oil products, such as diesel fuel and naphtha, are made in a similar manner as those used to treat sour gas and wastewater. When treating naphtha, for example, the pH is less important and works across a broad range. However, it has been found to be advantageous to increase the concentration of the transition metal compound somewhat.

Additional features and advantages will be set forth in part in the description that follows, and in part will be obvious from the description, or may be learned by practice of the embodiments disclosed herein. It is to be understood that both the foregoing brief summary and the following detailed description are exemplary and explanatory only and are not restrictive of the embodiments disclosed herein or as claimed.

### DETAILED DESCRIPTION

### Introduction

Disclosed herein are activated oxidizing compositions for removing H₂S and other sulfur compounds from sour gas streams, such as within or from a wellbore or a natural gas delivery line. Also disclosed are activated oxidizing compositions for removing H₂S and other sulfur compounds from other hydrocarbon fuels, such as diesel and naphtha, and wastewater, such as municipal sewer lines or wastewater produced when treating sour gas to remove H₂S. Also disclosed are activated oxidizing compositions for cleaning pipelines and providing anti-scaling and anti-corrosion effects.

The activated oxidizing compositions used to remove H₂S and other sulfur compounds from sour gas streams, other hydrocarbon fuels, and wastewater, and to clean pipelines and provide anti-scaling and anti-corrosion effects, comprise a mixture of aqueous sodium hypochlorite (oxidizing agent), a chelating agent (e.g., etidronic acid), and one or more transition metal compounds (e.g., iron compounds, such as ferric sulfate). The activated oxidizing compositions mainly differ in pH depending on use.

By way of background, the removal of H₂S and other sulfur compounds from sour gas streams, other hydrocarbon fuels, and wastewater, and cleaning of pipelines generally, involves strong oxidizing compositions that oxidize sulfur anions to elemental sulfur, which can be readily separated from the gas, liquid fuel, wastewater stream, or pipeline being treated and collected by known means, such as by filtering an aqueous slurry to form a filter cake.

There is a powerful reaction that produces several strong oxidative compounds, such as hydroxyl radicals, that can be used in “advanced oxidation” processes. For example, Fenton reagents or Fenton reactions can create oxidizing compounds from hydrogen peroxide (H₂O₂) or ozone (O₃). Traditionally, Fenton reagents are created in acidic pH ranges in order to be efficient and effective. Examples include ozone and ultraviolet (UV) light, ozone and hydrogen peroxide (H₂O₂) at low pH, H₂O₂ and UV light, ferrous (Fe²⁺) ions, H₂O₂, and UV light in a low pH environment, and the like. The combination of these compounds, especially with iron (Fe) compounds is known to produce hydroxyl radicals that are extremely reactive and can quickly break down compounds that are not as easily attacked by the strong oxidants individually that are used in the process. Hydroxyl radical formation is difficult to maintain or control but has become less unpredictable the past few decades as people have gained more experience with the process. Hydroxyl radical formation typically involves an acid reaction at low pH.

Recently, some companies have claimed they can produce modified Fenton reactions using various other oxidizers and with creative names to protect what they are doing from general knowledge. There is one study from overseas that mentions some success in mixing iron into wastewater, and then adding chlorine in order to reduce chemical oxygen demand (COD) in hard to treat municipal or industrial wastewater streams. This same approach has been less effective, however, on biological oxygen demand (BOD), and the study laments that achieving proper ratios is difficult and using too much may lessen the desired effects.

Another approach is to use caustic aqueous sodium hypochlorite by itself to treat wastewater without premixing with other components. However, the use of aqueous sodium hypochlorite has been found to be substantially inferior compared to the activated oxidizing compositions disclosed herein.

The inventor has 30 years of experience using strong oxidation technologies for a variety of purposes. These include using and generating ozone gas and its mass transfer to liquids in conjunction with H₂O₂ and also sodium and calcium hypochlorite as well as sulfuric acids. Over the years the inventor discovered and developed techniques to mix compounds that are not typically mixed together due to established known risks or undesirable reactions.

The activated oxidizing compositions disclosed herein are made with components that are generally understood to be incompatible with each other and should not be used in the manner disclosed. In particular, it is contrary to established norms and warnings to combine sodium hypochlorite with an acid and iron compound because doing so typically causes the generation and release of toxic gases. However, when mixed according to the present disclosure, the supposedly incompatible components do not in fact generate and emit significant quantities of toxic gases, but create effective activated oxidizing compositions, which is surprising and unexpected.

The invention disclosed herein involves a simple method to produce from supposedly incompatible components a reasonably stable and extremely effective activated oxidizing composition that exceeds any oxidation chemistry the inventor has used in his 30 years of experience. This includes being extremely efficient in oxidizing H₂S to elemental sulfur, even when used in very low amounts, which is a substantial improvement over known methods for removing H₂S and other sulfur compounds from sour gas, other hydrocarbon fuels, and wastewater. The chemistry does not rely exclusively on hydroxyl radical production, although it is reasonable to assume that some quantity of hydroxyl radicals are produced. The activated oxidizing compositions produce a wide range of oxidation and other reactions that synergistically produce a very powerful oxidizing composition for use in various treatments, including those disclosed herein.

### Activated Oxidizing Compositions

The activated oxidizing compositions disclosed herein are made by mixing aqueous sodium hypochlorite together with a chelating agent (e.g., etidronic acid) and a transition metal compound, such as an iron compound, to form a relatively stable and extremely aggressive activated oxidizing composition at a high pH (as compared to the currently accepted low pH Fenton reactions). The inventive activated oxidizing compositions are highly reactive when mixed into gaseous or liquid streams with an oxidative demand.

The activated oxidizing compositions destroy H₂S in gaseous and/or aqueous form and breaks up other sulfur compounds that can form H₂S in a liquid. By way of comparison, aqueous sodium hypochlorite is capable of oxidizing H₂S to elemental sulfur; however, the stoichiometric ratio typically ranges from 8-16 to 1. In contrast, the activated oxidizing compositions disclosed herein are effective at much lower stoichiometric ratios, which typically range from 1-3 to 1, when tested on municipal sewer collection systems within the liquid phase.

When used on a natural gas pipeline moving 2,375,000 cubic feet of gas per hour at 325 psi with a H₂S gas concentration of over 30 ppm, the H₂S was effectively removed in ten feet of pipe to concentrations of 0-4 ppm with an applied dosage of only 6 gallons of activated oxidizing composition per hour. In contrast, using 6 gallons of aqueous sodium hypochlorite by itself to treat 2,375,000 cubic feet of gas had zero effect—no significant amount of H₂S was removed.

The direct application of an atomized version of the activated oxidizing composition at very high pressure is able to contact and directly oxidize or absorb and oxidize the H₂S component of the gas stream with no diminishing effect on the rest of the gas or the pipeline. Not only do the activated oxidizing compositions not corrode the pipeline (though undiluted, the activator composition is extremely corrosive), they in fact protect the pipeline and reduce corrosion. The activated oxidizing composition and residual unreacted composition demonstrated an exceedingly strong cleaning or detergent effect within the pipeline, which removed built up contaminants and scale then protected the pipeline metals by acting as a barrier going forward.

The activated oxidizing compositions accomplish these things in the following ways. They break organic and chemical bonds very quickly through oxidation. In H₂S gaseous removal, the activated oxidizing compositions oxidize H₂S so quickly that its removal is completed within a matter of seconds and feet in a moving pipeline.

In addition, the activated oxidizing compositions break scales apart into their individual components. It is the inventor's experience, and is well documented in oceanographic studies, that many if not all naturally forming scales require a matrix around which to form. Such matrix is usually organic and exists as a result of mucinous compounds left over from microorganisms. The scale then forms layers by attaching to this organic compound and forming a structure, often in layers. The activated oxidizing compositions react with the scale and oxidize the organic material that the scale forms around. The material that formed the scale begins to rapidly fall away from the now destroyed matrix, and the combination of materials separates. Then what is oxidizable or reactive within the residue then goes through any remaining transformations until the fuel or the residual chemical (or newly formed chemicals) are exhausted. Many of the compounds of the activated oxidizing composition when produced are reactive in a water or wastewater environment. These have predictable benefits, but the unique combination of this chemistry consistently expedites those reactions.

It has been observed that the benefits provided by the various components in the activated oxidizing composition are not diminished by being mixed together but rather are enhanced. The anti-scale, de-scaling and anti-corrosion properties of the chelating agent benefit from the oxidizing species, which quickly penetrate and reach the bottom of existing contaminant layers in the pipeline. The reactions lift materials and allow the chelating agent to form a protective layer on the system metal. The strength of oxidation also reduces the rate of corrosion by forming an oxide layer on some system metal that is then resistant to further attack.

The transition metal compound (e.g., iron compound) is necessary to form the catalytic effect that significantly increases the speed of oxidation, either by aiding in the production of higher oxidative species or by catalytic effect as seen by other metal coated materials such as magnesium and aluminums.

Specifically within oil and dirt-contaminated liquid wastes in oil and gas fields, the iron compound, such as iron sulfate, has a demonstratable use in separation of emulsions via oxidation of weak chemical bonds that otherwise maintain emulsion stability. The presence of such strong oxidation chemistries show rapid separation of oil, minerals, and water.

### Activator Composition

The activator composition comprises an aqueous mixture of water, chelating agent, and transition metal compound.

The chelating agent provides various functions, as discussed herein, including stabilizing the transition metal compound and the resulting activated oxidizing composition. Examples of chelating agent that can be used herein include, but are not limited to, etidronic acid (also known as 1-hydroxyethylidene-1,1-diphosphonic acid and HEDP), ethylenediaminetetraacetic acid (EDTA), EDTA salts (e.g., sodium salts, such as mono-, di-, tri-, and tetrasodium salts), hydroxyethylethylenediaminetriacetic acid (HEDTA), HEDTA salts (e.g., trisodium salt of HEDTA, such as Versonal 120), ethylenediamine, amino acids, peptides, proteins, sugars, polysaccharides, citric acid, citrate salts, polyvalent carboxylic acids, salts of polyvalent carboxylic acids, and polynucleic acids. Etidronic acid is currently the preferred chelating agent, although it is believed that EDTA salts and Versonal 120 would also be effective chelating agents.

The transition metal compound provides various functions, as discussed herein, including forming an activator composition with the chelating agent in order to form powerful oxidation species when mixed with sodium hypochlorite and providing anti-corrosion and anti-scaling effects. Examples of preferred transition metal compounds include iron compounds, more preferably iron (III) compounds, and most preferably ferric sulfate.

In some embodiments, the activator composition, before being mixed with the sodium hypochlorite solution, includes the chelating agent at a concentration in a range of about 10% to about 25%, or about 12% to about 20%, or about 14% to about 18%. In some embodiments, the activator composition, before being mixed with the sodium hypochlorite solution, includes the transition metal compound at a concentration in a range of about 0.5% to about 5%, or about 0.75% to about 3%, or about 1% to about 2%.

### Sodium Hypochlorite Solutions

The sodium hypochlorite solutions that are mixed with the activator composition to form activated oxidation compositions as discloses can have any desired concentration, such as about 0.1% to about 20%, preferably about 5% to about 17.5%, more preferably about 10% to about 16%, and most preferably about 12% to about 15%, such as 15%.

### Method of Making Activated Oxidation Compositions

Although the activated oxidizing compositions disclosed herein can be safely made, handled, and used without significant release of toxic gases, care must be taken when producing the mixture to avoid formation of toxic gases and due to the warnings against mixing of these components.

Initially, it has been found to be undesirable to produce a composition possessing too much strength that may result in a runaway reaction. One way to avoid runaway reactions is to produce reasonable, rather than excessive, quantities of the composition, such as making less than tote-quantity batches. The activated oxidizing compositions can be produced in larger quantities but it may take a longer time to do so safely. Therefore, separately producing several tote quantities at once is safer and faster than making one large quantity. Thus, it has been found that 260-300 gallon (984-1,136 liter) tote quantities are the fastest and safest to produce.

A first step includes mixing a sodium hypochlorite solution within a tank or tote and keeping it moving (e.g., recirculating) preparatory to adding the activator composition. There may be a benefit in mixing a small amount of calcium hypochlorite into the sodium hypochlorite solution, but this has not yet been definitively proven.

Another step includes preparing a mixture of activator ingredients in water (e.g., 20% mixture of activator components), which is preferably deionized water and/or water treated by reverse osmosis (RO). By way of example, a 20% mixture preferably includes at least 18% acid (from the chelating agent), such as etidronic acid (HEDP), Versonol 120, or other effective chelating agent, preferably HEDP, and up to 2% of a pre-diluted ferric sulfate solution (e.g., diluted with water from 50% stock solution to 8%).

Once the sodium hypochlorite solution has been produced in desired quantities, a relatively small chemical injection pump can be utilized to begin slowly adding the activator solution into the recirculating main sodium hypochlorite solution. It is beneficial to keep the sodium hypochlorite solution agitated smoothly but not violently. One currently preferred method is to keep the sodium hypochlorite solution flowing during addition of the activator composition, which appears to be safer and produces little to no heat rise in the resulting mixed solution.

As the activator composition is added in small amounts to the flowing sodium hypochlorite solution, there will be a color change followed by a sudden drop in the whole batch pH. This pH drop is typically delayed because the sodium hypochlorite acts as a buffer that resists pH change, particularly since it constitutes the bulk of the mixture. However, over time once enough of the activator composition has been mixed in, the pH buffering effect will be overcome, and the pH will begin to drop. The final desired pH is dependent on the intended use of the activated oxidizing composition, as discussed herein.

For example, a product currently known as “SSH-100” is used for removing H₂S from sour gas, such as in natural gas pipelines and wellbores. To make SSH-100, a lesser amount of activator is added to adjust the pH to above 10.5, after which no more activator composition is added, or is slowly added, until the composition reaches an equilibrium pH between within a pH range of about 10-10.25. Mixing these ingredients to the point wherein the pH is stable within this range yields an activated oxidizing composition that gives the speed and power to destroy H₂S in either liquid streams or gaseous streams.

Another product is currently known as “EB-100”, which is used for cleaning pipelines and other equipment and to provide anti-scale and anti-corrosion properties. To make EB-100, a sufficient quantity of the activator composition is added to the sodium hypochlorite solution until the pH is adjusted to about 9.9, after which no more activator composition is added, or is slowly added, until the composition is allowed to reach an equilibrium pH between about 8.8 to 9.7. At this pH the proper mixture of ingredients produces the best results for cleaning and protecting pipelines and tanks.

SSH-100 and EB-100 have also been found to be useful in removing H₂S and other sulfur compounds from other hydrocarbon fuels, such as diesel and naphtha, and other oil products that contain sulfur compounds. This indicates that activated compositions across a broader pH work well for treating liquid hydrocarbons. Increasing the concentration of transition metal compound somewhat has been found to be helpful for treating liquid hydrocarbons.

A related product is currently known as “EB-50”, which is used as an emulsion breaker and is the strongest pipeline cleaning and provides the best anti-corrosion and anti-scaling barriers. This is made similar to EB-100, but has lower pH by continuing to add additional activator composition to the sodium hypochlorite solution until the pH is adjusted to between about 8 and 9.8, with a pH of 9.7 being very effective. Adjusting the pH to between 8.5 and 9.5 lessens the cleaning effect, but provides a superior barrier and descaling, which makes EB-50 well-suited for pipelines or other equipment that is already reasonably clean.

When used to treat sour gas via atomization, providing an activated oxidizing composition with a pH in a range of about 10-10.25 has been shown to be the most effective composition. If the pH is above or below this range, the H₂S concentrations can rapidly increase and the treatment may fail. The application of an atomized spray of this particular mixture is dependent on speed and absorption. When the pH is out of this range, the correct mixture of ingredients is not obtained to produce the strength or speed, such as the rate of absorption.

Another important variable is temperature. The reduction of H₂S is a speed dependent reaction and temperature greatly affects reaction speed. For atomization to remove H₂S, the best results are achieved at a liquid composition temperature above about 65° F. (18° C.) and below about 100° F. (38° C.). When the temperature is less than 65° F. (18° C.), the reaction is slowed down, with diminished results. When the temperature is greater than 100° F. (38° C.), the activated oxidizing composition can degrade and cause rapid off-gassing of chlorine, thus weakening the composition, which can lead to it eventually failing. When the temperature is too low, the oxidizing activity of the composition is weakened, and more of the composition is required to work properly at below 65° F. (18° C.) down to freezing.

The components of the activated oxidizing composition can be aggressive toward metals; however, once diluted into an environment with an oxidative demand, the composition unexpectedly and unpredictably behaves in the opposite manner and actually protects system metals. In order to pump or handle the activated oxidizing composition under pressure prior to its release in the treatment environment, it is preferable to use specially coated Hastelloy, titanium, and 316 SS fittings. The 316 SS fittings are otherwise destroyed without an applied coating, which can be a mixture of Teflon and ceramic. The Hastelloy also benefits from this coating. Without the protective coating, the activated oxidizing composition can eat through and destroy the fittings and connections within a matter of a few days and can plug or corrode the application plumbing, rendering it useless in a short time. There currently are no other known protective coatings that are compatible with the activated oxidizing composition.

In summary, the activated oxidizing composition, when mixed properly with due care and respect to its dangers if improperly prepared, forms a reasonably stable final product that can remain active for several weeks. When exposed to a reactive demand, the activated oxidizing composition contains numerous strong oxidative compounds, among which are chlorine compounds, hypochlorous acids, oxygen species, and other higher oxidative state compounds that work synergistically to speed the oxidation of compounds that would normally require additional time and amounts of oxidizing agent. The composition wipes out bacteria counts and biofilms that protect bacteria, exposing the system metal to the protective layers produced. Compounds such as scales and emulsions appear to be attacked at the bonds that hold them together. And this can be achieved at a very high rate of speed using a mixture of chemicals that established science says should never be mixed together.

It is important to realize that adding the activator composition to lower the pH of the sodium hypochlorite composition can release some amount of chlorine gas and possibly some hydrogen. Thus, mixing should be performed in a well-ventilated area while using protective gear for breathing, eyes, and hands.

In addition, the temperature of the product should be frequently checked as the components are being mixed. If there is a significant temperature rise or visible gas leaving the product, additional activator composition should not be added until the temperature goes down and there is no visible gas leaving the product.

It has been found that the product is the most reactive and possibly dangerous when mixed rapidly in small amounts of 10 gallons (38 liters) or less, down to 20 mL (0.68 oz). This is mostly due to adding the activator too quickly without keeping the liquid moving. A rapid runaway reaction can occur by mixing too rapidly. Also, a runaway reaction can occur when there is too much energy available for the reaction, as in the case of making large quantities, e.g., more than 300 gallons (1,136 liters).

The reaction can become highly unstable and become exothermic and volatile very quickly with very small amounts of the activator chemistry. Thus, it is desirable to only prepare the activated oxidizing composition in 260 gallon (984 liter) or 300 gallon (1,136 liter) tote quantities. These amounts have been found to be the most forgiving to the mixing and reacting process. Nonetheless, caution still must be used because the chemical can release chorine and other oxidants of volatile gases, but it is much slower and when done correctly over a small amount at a time with gentle movement there is no exothermic reaction and the product remains stable. After the mixed product has rested for several hours to overnight, it will remain stable for many weeks, only very slowly losing some strength after about two weeks but still remaining very strong and useful.

Etidronic acid is the preferred chelating agent and works the best. Versonal 120 and many other chelating agents can be used to produce the activator composition, but they require from 4 to 10 minutes to react with the sodium hypochlorite and produce the activated oxidizing composition. The chemical mixture will set during that time and then there will be a rise in temperature accompanied by a change in color and the sudden appearance of gas bubbles. This causes a rapid drop in pH to the range needed, and the chemical is ready. Therefore, care must be taken to stop adding activator composition at the correct pH with the expectation that it may release gas and the pH may drop again. There is a short window to use this mixture to get the strongest results. When using HEDP and the proper amount of ferric sulfate the activated oxidizing composition is ready as soon as the components are added together and the correct pH range has been attained. There is no need to provide a set amount of contact time. The reaction is stronger and requires less overall volume to achieve the results.

### Methods of Using Activated Oxidizing Compositions

In some embodiments, an appropriate activated oxidizing composition having the proper pH (e.g., SSH-100), as disclosed herein, is injected directly into gas pipelines in an atomized spray at pressures between 100-600 psi to remove H₂S gas from the natural gas and clean and protect the pipes.

In some embodiments, an appropriate activated oxidizing composition having the proper pH (e.g., EB-100), as disclosed herein, is added in liquid form to wastewater pipelines to clean, descale, and protect against corrosion. The activated oxidizing composition can also be used to remove H₂S or other sulfur-based compounds. For example, the activated oxidizing composition in very dilute form can be applied to municipal sewer collection systems to remove H₂S and protect infrastructure.

In some embodiments, SSH-100 and EB-100 can be blended in liquid form with a liquid hydrocarbon fuel, such as diesel or naphtha, or other oil product, to oxidize and remove H₂S and optionally other sulfur compounds.

Lastly, an activated oxidizing composition (e.g., EB-50) can be used as a down hole well treatment that cleans oil and gas wells. This destroys bacteria, lowers corrosion, and breaks down iron scales. It may break down barium and calcium scales as well. In a first 6-month trial, and within two weeks, the activated oxidizing composition was found to have opened up access points to gas and increased well gas production by over 20% without the wells being optimized or controlled properly for the larger capacity. Within two weeks of the end of the trial period, the gas levels returned to the lower flows. A new trial is planned to repeat the result on a dirty well pad. It is expected that this will restore gas production. The activated oxidizing composition is mixed and pressure injected down the backside of the well bore to the bottom of the well. In order to keep up with requirement, a new batch of activated oxidizing composition can be produced every few days, or as needed.

### EXAMPLES

The examples describe exemplary oxidizing compositions suitable for oxidizing H₂S to elemental sulfur while treating sour gas, other hydrocarbon fuels, and wastewater, cleaning pipelines, and proving anti-corrosion and anti-scaling effects.

### Example 1—Activator composition

An aqueous activator composition for subsequent mixing with a sodium hypochlorite solution to form various activated oxidizing compositions suitable for removing H₂S and other sulfur compounds from natural gas pipelines, other hydrocarbon fuels, and wastewater and/or to provide anti-corrosion and anti-scaling properties, was made in multiple steps, including forming an etidronic acid solution and adding a diluted ferric sulfate solution to the etidronic acid solution to form the activator composition.

A 15 gallon (57 liter) drum of activator solution was prepared as follows. First, an initial etidronic acid mixture was made by mixing 3 gallons (11.3 liters) of etidronic acid into 8 gallons (30.3 liters) of water together with gentle mixing to avoid incorporating significant amounts of air into the water. Thereafter, an additional 3 gallons (11.3 liters) of water was added to the initial mixture to form the etidronic acid solution.

Second, a diluted ferric sulfate solution was made separately by mixing between 454.2 mL to 554.2 mL of concentrated ferric sulfate solution (50%) into 2 gallons (7.6 liters) of water together with gentle stirring to avoid incorporating significant amounts of air into the water. In general, the amount of concentrated ferric sulfate solution added to 2 gallons (7.6 liters) of water can be in a range of about 400 mL (13.5 oz) to about 600 mL (20.3 oz), or about 425 mL (14.4 oz) to about 575 mL (19.4 oz), depending on the desired activity of the activator solution. Using too little ferric sulfate solution in the activator solution can yield an unsafe mixture when added to a strong sodium hypochlorite solution (12-15%).

Then the diluted ferric sulfate solution (approximately 2 gallons (7.6 liters)) was slowly added to the etidronic acid solution, and immediately thereafter an additional quantity of water was added to produce 15 gallons (57 liters) of activator composition. This mixture was gently stirred or circulated for 30 seconds to 1 minute to avoid unnecessary air addition. It was found that the activator composition can be stored for 2-3 weeks without significant loss of potency. The drum was closed loosely and allowed to vent. After 1 hour, the lid was tightened up.

After 3 weeks, the activator composition was still effective but became less potent, requiring more of it to produce an activated oxidizing composition having the desired pH and oxidizing activity. Making larger quantities has been found to accelerate weakening of the activator composition.

### Example 2—SSH-100 Activated Oxidizing Composition for Removing H₂S From Gas Pipelines and Other Hydrocarbons

An activated oxidizing composition for removing H₂S from gas pipelines and other hydrocarbon fuels, such as diesel or naphtha (SSH-100) was made by slowly adding the activator composition of Example 1 to an aqueous sodium hypochlorite solution (15%) with constant stirring to adjust the pH to between about 10.10 to about 10.30, with a pH of about 10.2 working the best. It was found that there was a delay in pH reduction, meaning that the pH continued to drop after adding the activator composition to an aqueous sodium hypochlorite solution.

It was found that blending the activator on the fly with the 15% sodium hypochlorite solution produces the most active oxidizing composition. This is accomplished using a sophisticated pH controller with safeties and alarms to prevent mishap. The activated oxidizing composition can also be pre-mixed and remain stable for several weeks, although it appears to be somewhat less reactive than when the composition is mixed on the fly.

There is no wait time needed once the activated oxidizing composition has reached the required pH; it is ready to react with contaminants in the atomization, or in a pipeline or down hole. With the exception of atomization, pre-mixed SSH-100 is capable of working and will last after mixing up to 2 weeks.

The activated oxidizing composition was atomized and injected into a natural gas line to reduce H₂S to elemental sulfur, which was removed from the pipeline by known means. The stoichiometric ratio of activated sodium hypochlorite to H₂S was about 1-3:1.

The activated oxidizing composition was also used to remove H₂S from naphtha by treating 400 mL samples of naphtha with 1 mL of activated oxidizing composition. The activated oxidizing composition can also be used to treat other hydrocarbon fuels, such as diesel, and other oil products. Any oil product contaminated with H₂S can be treated using the activated oxidizing composition.

The best results are achieved when SSH-100 is produced on the fly, which yields the strongest and fastest acting oxidizing composition. It is also predicted that SSH-100 will likely prove to be highly effective in down hole applications, which will soon be tested on well pads. For this application, the pre-mixed version is believed to be the most suitable.

### Example 3—EB-100 Activated Oxidizing Composition for Removing H₂S From Wastewater and Liquid Hydrocarbons

An activated oxidizing composition (EB-100) for removing H₂S and other sulfur compounds from wastewater and liquid hydrocarbons was made by slowly adding the activator composition of Example I to an aqueous sodium hypochlorite solution (15%) with constant stirring to adjust the pH to between about 9.0 about 10.10. It was found that the amount of activator composition required to break the buffering effect of the sodium hypochlorite solution can vary with the age and strength of the activator composition.

It is important for the pH to be adjusted to the proper levels in order for the activated oxidizing composition to have the properties required to achieve the intended results. In addition, it does not only need to be at a specific pH but also requires the correct amount of the activator composition (both the endotronic acid and the mineral content) to cause the lowered pH. This pH is arrived at slowly and allowed to fall into the desired range then tweaked very slightly to reach the target pH.

The activated oxidizing composition was used for wastewater treatment of pipelines to prevent H₂S production and/or escape from the liquid when opening filters or pipes. The activated oxidizing composition oxidized H₂S and other sulfur compounds to elemental sulfur, which was removed from the wastewater by known means.

EB-100 is especially useful for use in salt water disposal (SWD) pipelines and wells and other wastewater applications for removing the ability of the water to release or produce H₂S. This mixture is also a better pipeline cleaner and demulsifier compared to SSH-100. Applications well suited for using EB-100 are saltwater disposal pipelines, tanks, filters, and disposal wells. In addition, EB-100 is well suited for municipal wastewater sewage collection systems even though it contains diluted sodium hypochlorite (e.g., 1% to 2%).

EB-100 may also be suitable as an emulsion breaker, to treat landfill leachate and industrial streams requiring oxidation and biofilm destruction. EB-100 has also been used to treat naphtha to remove H₂S and other sulfur compounds.

### Example 4—EB-50 Activated Oxidizing Composition for Cleaning Pipelines

An activated oxidizing composition for use as an emulsion breaker and that was the strongest pipeline cleaner and provided the best anti-corrosion and anti-scaling effects (EB-50) was made by slowly adding the activator composition of Example 1 to an aqueous sodium hypochlorite solution (15%) with constant stirring to adjust the pH to within a range between 8 and 9.8, with a pH of 9.7 being very effective. Further reducing the pH lessens the cleaning effect but increases the barrier effect. So if the pipeline being treated is relatively clean, a pH of about 8.5-9.5 is a formidable product for providing good barrier and descaling effects.

The activated oxidizing composition was injected into a natural gas pipeline to clean the gas line and provide anti-corrosion and anti-scaling effects.

EB-50 is a good pipeline protector. EB-50 can be produced by reducing the pH below the pH levels best for EB-100. EB-50 is not as effective as EB-100 for removing H₂S but is a stronger pipeline protectant. It also demonstrates strong cleaning ability and scale destruction. All of the activated oxidizing compositions can remove and protect from scaling, but EB-50 is better because of the additional quantity of chelating agent required to lower the pH to below 9.9.

### Comparative Example A

A sodium hypochlorite solution having a concentration of 15% was used to remove H₂S from a natural gas pipeline. In order to be effective in oxidizing H₂S to elemental sulfur, the stoichiometric ratio of sodium hypochlorite to H₂S was between 8-16:1.

There is no comparison between a 15% sodium hypochlorite solution and the activated oxidizing composition made using 15% sodium hypochlorite solution. The speed and power of the new activated oxidizing composition are orders of magnitude faster and more complete than a 15% sodium hypochlorite solution when reacting with compounds and contaminants.

One test was performed using red dye. A 12-15% sodium hypochlorite solution takes 100 to 1000 times longer to clear red dye from a treated sample compared to the activated oxidizing compositions. A sodium hypochlorite solution, even at the correct pH for atomization, has little to no effect on H₂S content. Sodium hypochlorite solutions have no effect on hard scales but the activated oxidizing compositions do. Even though the activated oxidizing compositions are not acidic, they nonetheless are effective in destroying iron scales. They are also promising against barium scales and calcium scales and have a devastating effect on biofilms and biological materials.

### Other Examples

Following are some further example embodiments of the invention. These are presented only by way of example and are not intended to limit the scope of the invention in any way. Further, any example embodiment can be combined with one or more of the example embodiments.

Embodiment 1: An oxidizing composition for removing hydrogen sulfide (H₂S) from a gaseous or liquid stream comprising mixture products of water, sodium hypochlorite, a chelating agent, and a transition metal compound.

Embodiment 2: The oxidizing composition of embodiment 1, wherein the composition is formed by: combining a first portion of the water, chelating agent, and transition metal compound to form an activator composition; and mixing the activator composition with a sodium hypochlorite solution comprising the sodium hypochlorite and a second portion of the water.

Embodiment 3: The oxidizing composition of any of embodiments 1-2, wherein the activator composition, before being mixed with the sodium hypochlorite solution, includes the chelating agent at a concentration in a range of about 10% to about 25%, or about 12% to about 20%, or about 14% to about 18%

Embodiment 4: The oxidizing composition of any of embodiments 1-3, wherein the activator composition, before being mixed with the sodium hypochlorite solution, includes the transition metal compound at a concentration in a range of about 0.5% to about 5%, or about 0.75% to about 3%, or about 1% to about 2%.

Embodiment 5: The oxidizing composition of any of embodiments 1-4, wherein the sodium hypochlorite solution, before being mixed with the activator composition, includes the sodium hypochlorite at a concentration in a range of about 0.1% to about 20%, or about 5% to about 17.5%, or about 10% to about 16%, or about 12% to about 15%.

Embodiment 6: The oxidizing composition of any of embodiments 1-5, wherein the chelating agent comprises etidronic acid.

Embodiment 7: The oxidizing composition of any of embodiments 1-6, wherein the chelating agent comprises at least one of ethylenediaminetetraacetic acid (EDTA), EDTA salts, hydroxyethylethylenediaminetriacetic acid (HEDTA), HEDTA salts, ethylenediamine, amino acids, peptides, proteins, sugars, polysaccharides, citric acid, citrate salts, polyvalent carboxylic acids, salts of polyvalent carboxylic acids, and polynucleic acids

Embodiment 8: The oxidizing composition of any of embodiments 1-7, wherein the transition metal compound comprises an iron compound.

Embodiment 9: The oxidizing composition of embodiment 8, wherein the iron compound comprises an iron (III) compound.

Embodiment 10: The oxidizing composition of any of embodiments 8-9, wherein the iron compound comprises ferric sulfate.

Embodiment 11: The oxidizing composition of any of embodiments 1-10, wherein the oxidizing composition is formulated to remove H₂S from natural gas in a natural gas pipeline or other hydrocarbon fuel and has a pH in a range of about 9.8 to about 10.5, or about 10 to about 10.3, or about 10.2.

Embodiment 12: The oxidizing composition of any of embodiments 1-10, wherein the oxidizing composition is formulated to remove H₂S from wastewater selected from municipal sewage and wastewater produced by cleaning natural gas pipelines, and also liquid hydrocarbon products, and has a pH in a range of about 9.0 to about 10.1, or about 9.6 to about 10, or about 9.7.

Embodiment 13: The oxidizing composition of any of embodiments 1-10, wherein the oxidizing composition is formulated to clean pipelines and provide anti-scaling and anti-corrosion effects and has a pH in a range of about 8 to about 9.8, or about 8.5 to about 9.5, or about 8.8 to about 9.4.

Embodiment 14: An oxidizing composition for removing hydrogen sulfide (H₂S) from a gaseous or liquid stream made by a process comprising: combining water, a chelating agent, and a transition metal compound to form an activator composition having an acidic pH; and mixing a quantity of the activator composition with a sodium hypochlorite solution comprising sodium hypochlorite and water to yield an oxidizing composition having a desired pH.

Embodiment 15: The oxidizing composition of embodiment 14, wherein mixing the activator composition with a sodium hypochlorite solution is performed while stirring the sodium hypochlorite solution.

Embodiment 16: The oxidizing composition of any of embodiments 14-15, wherein the sodium hypochlorite solution has an initial pH of about 11 to about 13 before being mixed with the activator composition.

Embodiment 17: The oxidizing composition of any of embodiments 14-16, wherein the quantity of the activator composition mixed with the sodium hypochlorite solution produces an oxidizing composition having a pH in a range of about 9.8 to about 10.5, or about 10 to about 10.3, or about 10.2, and that is suitable for removing H₂S from natural gas in pipelines and other hydrocarbon fuels.

Embodiment 18: The oxidizing composition of any of embodiments 14-16, wherein the quantity of the activator composition mixed with the sodium hypochlorite solution produces an oxidizing composition having a pH in a range of about 9.0 to about 10.1, or about 9.6 to about 10, or about 9.7, and that is suitable for removing H₂S from wastewater.

Embodiment 19: The oxidizing composition of any of embodiments 14-16, wherein the quantity of the activator composition mixed with the sodium hypochlorite solution produces an oxidizing composition having a pH in a range of about 8 to about 9.8, or about 8.5 to about 9.4, or about 8.8 to about 9.4, and that is suitable for cleaning pipelines and providing anti-scaling and anti-corrosion effects.

Embodiment 20: A method of manufacturing an oxidizing composition, comprising: combining water, a chelating agent, and a transition metal compound to form an activator composition having an acidic pH; and mixing a quantity of the activator composition with a sodium hypochlorite solution comprising sodium hypochlorite and water to yield an oxidizing composition having a desired pH.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An oxidizing composition for removing hydrogen sulfide (H₂S) from a gaseous or liquid stream comprising mixture products of:
water;
sodium hypochlorite;
a chelating agent; and
a transition metal compound.

2. The oxidizing composition of claim 1, wherein the composition is formed by:
combining a first portion of the water, chelating agent, and transition metal compound to form an activator composition; and
mixing the activator composition with a sodium hypochlorite solution comprising the sodium hypochlorite and a second portion of the water.

3. The oxidizing composition of claim 2, wherein the activator composition, before being mixed with the sodium hypochlorite solution, includes the chelating agent at a concentration in a range of about 10% to about 25%, or about 12% to about 20%, or about 14% to about 18%.

4. The oxidizing composition of claim 2, wherein the activator composition, before being mixed with the sodium hypochlorite solution, includes the transition metal compound at a concentration in a range of about 0.5% to about 5%, or about 0.75% to about 3%, or about 1% to about 2%.

5. The oxidizing composition of claim 2, wherein the sodium hypochlorite solution, before being mixed with the activator composition, includes the sodium hypochlorite at a concentration in a range of about 0.1% to about 20%, or about 5% to about 17.5%, or about 10% to about 16%, or about 12% to about 15%.

6. The oxidizing composition of claim 1, wherein the chelating agent comprises etidronic acid.

7. The oxidizing composition of claim 1, wherein the chelating agent comprises at least one of ethylenediaminetetraacetic acid (EDTA), EDTA salts, hydroxyethylethylenediaminetriacetic acid (HEDTA), HEDTA salts, ethylenediamine, amino acids, peptides, proteins, sugars, polysaccharides, citric acid, citrate salts, polyvalent carboxylic acids, salts of polyvalent carboxylic acids, and polynucleic acids.

8. The oxidizing composition of claim 1, wherein the transition metal compound comprises an iron compound.

9. The oxidizing composition of claim 8, wherein the iron compound comprises an iron (III) compound.

10. The oxidizing composition of claim 8, wherein the iron compound comprises ferric sulfate.

11. The oxidizing composition of claim 1, wherein the oxidizing composition is formulated to remove H₂S from natural gas in a natural gas pipeline or other hydrocarbon fuel and has a pH in a range of about 9.8 to about 10.5, or about 10 to about 10.3, or about 10.2.

12. The oxidizing composition of claim 1, wherein the oxidizing composition is formulated to remove H₂S from wastewater selected from municipal sewage and wastewater produced by cleaning natural gas pipelines, and also liquid hydrocarbon products, and has a pH in a range of about 9.0 to about 10.1, or about 9.6 to about 10, or about 9.7.

13. The oxidizing composition of claim 1, wherein the oxidizing composition is formulated to clean pipelines and provide anti-scaling and anti-corrosion effects and has a pH in a range of about 8 to about 9.8, or about 8.5 to about 9.5, or about 8.8 to about 9.4.

14. An oxidizing composition for removing hydrogen sulfide (H₂S) from a gaseous or liquid stream made by a process comprising:
combining water, a chelating agent, and a transition metal compound to form an activator composition having an acidic pH; and
mixing a quantity of the activator composition with a sodium hypochlorite solution comprising sodium hypochlorite and water to yield an oxidizing composition having a desired pH.

15. The oxidizing composition of claim 14, wherein mixing the activator composition with a sodium hypochlorite solution is performed while stirring the sodium hypochlorite solution.

16. The oxidizing composition of claim 14, wherein the sodium hypochlorite solution has an initial pH of about 11 to about 13 before being mixed with the activator composition.

17. The oxidizing composition of claim 16, wherein the quantity of the activator composition mixed with the sodium hypochlorite solution produces an oxidizing composition having a pH in a range of about 9.8 to about 10.5, or about 10 to about 10.3, or about 10.2, and that is suitable for removing H₂S from natural gas in pipelines and other hydrocarbon fuels.

18. The oxidizing composition of claim 16, wherein the quantity of the activator composition mixed with the sodium hypochlorite solution produces an oxidizing composition having a pH in a range of about 9.0 to about 10.1, or about 9.6 to about 10, or about 9.7, and that is suitable for removing H₂S from wastewater.

19. The oxidizing composition of claim 16, wherein the quantity of the activator composition mixed with the sodium hypochlorite solution produces an oxidizing composition having a pH in a range of about 8 to about 9.8, or about 8.5 to about 9.4, or about 8.8 to about 9.4, and that is suitable for cleaning pipelines and providing anti-scaling and anti-corrosion effects.

20. A method of manufacturing an oxidizing composition, comprising:
combining water, a chelating agent, and a transition metal compound to form an activator composition having an acidic pH; and
mixing a quantity of the activator composition with a sodium hypochlorite solution comprising sodium hypochlorite and water to yield an oxidizing composition having a desired pH.
